(19) United States
(12) Patent Application Publication
(10) Pub. No.: US 2021/0398022 A1
(43) Pub. Date: Dec. 23, 2021

(54) METHOD AND APPARATUS OF FUSING OPERATORS, ELECTRONIC DEVICE AND STORAGE MEDIUM

(71) Applicant: Beijing Baidu Netcom Science Technology Co., Ltd., Beijing (CN)

(72) Inventors: Guibin WANG, Beijing (CN); Yangkai XU, Beijing (CN); Huanxin ZHENG, Beijing (CN); Yue GUO, Beijing (CN)

(21) Appl. No.: 17/463,748

(22) Filed: Sep. 1, 2021

(30) Foreign Application Priority Data
Oct. 22, 2020 (CN) 202011139137.7

(51) Int. Cl. G06N 20/00

(52) U.S. Cl. CPC G06N 20/00

(57) ABSTRACT

The present disclosure provides a method and apparatus of fusing operators, an electronic device and a storage medium, which relates to fields of deep learning, artificial intelligence and knowledge graph. The method includes: determining operator groups to be fused, according to an operator graph to be processed, wherein each operator group of the operator groups includes at least two operators in the operator graph respectively; obtaining a fused operator corresponding to the each operator group respectively; and for the fused operator, replacing corresponding operators in the operator graph with the fused operator respectively, and coupling dependence edges of the corresponding operators to the any fused operator, wherein the corresponding operators include operators in the operator group corresponding to the fused operator.

### CROSS-REFERENCE TO RELATED APPLICATION(S)

This application claims priority to the Chinese Patent Application No. 202011139137.7, filed on Oct. 22, 2020, which is incorporated herein by reference in its entirety.

### TECHNICAL FIELD

The present disclosure relates to computer application technology, and in particular to a method and apparatus of fusing operators, an electronic device and a storage medium in fields of deep learning, artificial intelligence and knowledge graph.

### BACKGROUND

Deep learning technology is more and more widely used, for example, in fields of voice processing, image processing, natural language processing, etc.

With a deep learning model continuously enlarging and training data substantially growing, computing demands for deep learning may not be satisfied. Therefore, speed optimization is always a problem to be solved.

### SUMMARY

The present disclosure provides a method and apparatus of fusing operators, an electronic device and a storage medium.

The method of fusing operators, including:

determining operator groups to be fused, according to an operator graph to be processed, wherein each operator group of the operator groups includes at least two operators in the operator graph respectively;

obtaining a fused operator corresponding to the each operator group respectively; and

for the fused operator,

replacing corresponding operators in the operator graph with the fused operator respectively, and

coupling dependence edges of the corresponding operators to the any fused operator,

wherein the corresponding operators include operators in the operator group corresponding to the fused operator.

The apparatus of fusing operators, including a group obtaining module, an operator fusing module and an operator replacing module, wherein,

the group obtaining module is configured to determine operator groups to be fused, according to an operator graph to be processed, wherein each operator group of the operator groups includes at least two operators in the operator graph respectively;

the operator fusing module is configured to obtain a fused operator corresponding to the each operator group respectively; and

the operator replacing module is configured to, for the fused operator, replace corresponding operators in the operator graph with the fused operator respectively, and couple dependence edges of the corresponding operators to the any fused operator, wherein the corresponding operators include operators in the operator group corresponding to the fused operator.

The electronic device, including:

at least one processor; and

a memory, communicatively coupled with the at least one processor; wherein,

the memory stores instructions capable of being executed by the at least one processor, and the instructions, when executed by the at least one processor, cause the at least one processor to perform the method described above.

A non-transitory computer readable storage medium storing computer instructions and configured to cause the computer to perform the method described above.

It should be understood that the description in this section is not intended to identify critical or important features of the embodiments of the present disclosure, and the description is not intended to limit the scope of the present disclosure. Other features of the present disclosure will become easy to understand according to the following description.

### BRIEF DESCRIPTION OF THE ACCOMPANYING DRAWINGS

The drawings are for a better understanding of the present disclosure and do not constitute a limitation of the present application, in which:

FIG. 1 is a flowchart of a method of fusing operators according to some embodiments of the present disclosure;

FIG. 2 is a schematic composition structure diagram of an apparatus 20 of fusing operators according to some embodiments of the present disclosure; and

FIG. 3 is a block diagram of an electronic device according to some embodiments of the present application.

### DETAILED DESCRIPTION

The following describes the exemplary embodiments of the present application in combination with the accompanying drawings, including various details of the embodiments of the present application for the sake of understanding, which should be considered as only exemplary. Therefore, those skilled in the art should recognize that various changes and modifications may be made to the embodiments described herein without departing from the scope and spirit of the present application. Similarly, for the sake of clarity and conciseness, the description of well-known functions and structures is omitted in the following description.

In addition, it should be understood that the term “and/or” in this paper is only a description of the association relationship of associated objects, which means that there may be three kinds of relationships, for example, a and/or B, which may mean that there are three cases: a alone, a and B at the same time, and B alone. In addition, the character ‘I’ in this paper generally means that the associated object is a “or” relationship.

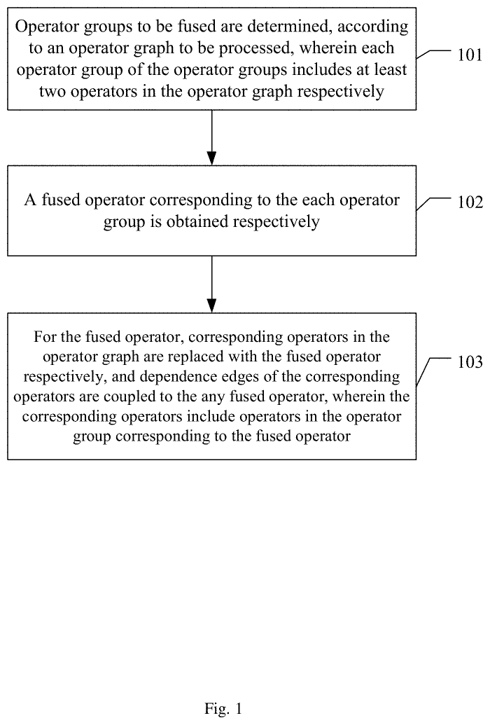

FIG. 1 is a flowchart of a method of fusing operators according to some embodiments of the present disclosure. As shown in FIG. 1, the following operations are included.

In operation 101, operator groups to be fused are determined, according to an operator graph to be processed. Each operator group of the operator groups includes at least two operators in the operator graph respectively.

In operation 102, a fused operator corresponding to the each operator group is obtained respectively.

In operation 103, for the fused operator, corresponding operators in the operator graph are replaced with the fused operator respectively, and dependence edges of the corresponding operators are coupled to the any fused operator. The corresponding operators include operators in the operator group corresponding to the fused operator.

According to the embodiments above, a method of automatically fusing operators in a lateral direction is proposed for deep learning. A fused operator for a plurality of operators may be generated to replace corresponding operators, so as to realize a fusion of operators. Thus, a computing efficiency and a training speed of a deep learning model may be improved.

As described in operation 101, the operator groups to be fused may be determined according to the operator graph to be processed. An operator graph is an organization form of operators in a network. In an operator graph, each node corresponds to different operators in the network. An operator is a minimum computing granularity having logical meanings. A dependence graph (i.e., the operator graph) of operators may be established based on a producer-consumer relationship of the operators. Corresponding nodes may be coupled via edges (dependence edges) according to data transmission relationship between operators.

As an optional implementation, a first processing as follows may be performed, so as to determine the operator groups to be fused. Operators in the operator graph are traversed. For each traversed operator in the operator graph, if it is determined that there is no dependence relationship between the each traversed operator and the any other operator, then an operator pair including the each traversed operator and any other operator is constructed, and the operator pair is set as a new operator, so as to replace the any traversed operator and the any other operator (that is, the two operators are replaced with the new operator, so that a number of the operators is reduced by one), and the dependence edges of the any traversed operator and the dependence edges of the any other operator are coupled to the new operator. The operators including at least two operators in the operator graph may be set as the operator groups to be fused, if it is determined that a termination condition is satisfied; and the first processing is re-performed, if it is determined that the termination condition is not satisfied.

The method for traversing the operators in the operator graph is not limited in the present disclosure, and may be determined as needed. For example, a breadth-first traversal may be adopted.

For each traversed operator such as an operator a, if it is determined that there is no dependence relationship between the operator a and any other operator such as an operator b (that is, if the operator b is not directly or indirectly coupled with the operator a via an edge), an operator pair including the operator a and the operator b may be constructed. Furthermore, the operator pair including the operator a and the operator b may be set as a new operator, so as to replace the operator a and the operator b, and dependence edges of the operator a and dependence edges of the operator b may be coupled to the new operator.

After the new operator (referred to as an operator ab) including the operator a and the operator b is added into the operator graph, the operator ab may further be used to construct an operator pair with another operator such as an operator c. Thus, it is possible to obtain an operator pair (referred to as an operator abc) including the operator a, the operator b and the operator c. Accordingly, the operator pair abc may further be set as a new operator in the operator graph, so as to replace the operator ab and the operator c, and dependence edges of the operator ab and dependence edges of the operator c may be coupled to the operator abc.

The process above may be re-performed until a termination condition is satisfied. If the termination condition is satisfied, the operators including at least two operators in the operator graph may be set as the operator groups to be fused respectively. For example, if the operator abc is not included in a constructed operator pair when the termination condition is satisfied, the operator abc including the operator a, the operator b and the operator c may be regarded as an operator groups to be fused.

In a practical application, an operator may have an attribute indicating whether the operator is fusible. Generally, a non-fusible operator may not be processed according to the method described in the present disclosure.

Therefore, before the first processing, fusible operators may be selected from the operators in the operator graph, so that a first operator set contains the selected fusible operators. In this manner, it is possible to determine whether both the any traversed operator and the any other operator are located in the first operator set, before determining that there is no dependence relationship between the each traversed operator and the any other operator. If it is determined that both the any traversed operator and the any other operator are located in the first operator set, the operator pair including the any traversed operator and the any other operator may be constructed, and subsequent processing may be performed. That is, an operator pair may be generated only if both the any traversed operator and the any other operator are located in the first operator set.

The termination condition may include failing to generate a new operator pair. In this case, there is no fusible operator. Alternatively, the termination condition may include a number of operators in a new generated operator pair being greater than a predetermined threshold. In this case, a new operator pair may be generated, but a number of operators in the new generated pair may be greater than a predetermined threshold.

A specific value of the predetermined threshold may be determined as needed. For example, the predetermined threshold may be set as a predetermined fused breadth constraint L, and the predetermined fused breadth constraint L may be a positive integer L greater than 1.

For example, if L equals to 3, only three or fewer operators may be included in an operator pair. If a number of operators in a new generated operator pair is 4 (greater than the threshold 3), it is considered that the termination condition is satisfied. In addition, the above threshold is only an example, and it is not necessary that the value of the threshold should be an integer.

According to the processing above, the operator groups to be fused may be found as much as possible, laying a good foundation for the subsequent processing, and ensuring an accuracy of obtaining the operator groups to be fused.

As described in operation 102, the fused operator corresponding to the each operator group may be obtained respectively. For example, a plurality of operators having no dependence relationship from each other may be fused into one operator (i.e., the fused operator may be obtained) based on an online compiling method of generating an operator.

As an optional implementation, fusing codes for the each operator group may be obtained; and the fused operator may be obtained, by compiling the fusing codes to generate binary codes.

Fusing codes for each operator group sᵢ may be obtained according to following operations.

1) For each operator vᵢ (vᵢϵsᵢ) in each operator group sᵢ, source codes kᵢ for the operator vᵢ and a thread space bᵢ for the operator vᵢ are obtained respectively.

2) The obtained thread spaces are fused, that is B=Σbᵢ.

3) A thread space for the fusing codes is declared, according to the fused thread space B.

4) Computing process is allocated for each thread subspace to complete executions for kᵢ.

5) A parameter list of the fusing codes is constructed, by generating a union of parameter lists for all the kᵢ.

For example, it is assumed that there are two operators included in an operator group sᵢ, and each of the two operators corresponds to a source code respectively. A new operator is generated based on the two operators, and the new operator may implement the same operations as the two operators. Accordingly, new codes not existed before should be generated.

Then, the fusing codes may be compiled to generate the binary codes according to following operations.

1) A nvrtcProgram object is created by using nvrtcCreateProgram, that is, the source codes (fusing codes) are encapsulated as a nvrtcProgram object by using nvrtcCreateProgram.

2) Framework parameters of a current graphics processing unit (GPU) are obtained by using cudaDeviceGetAttribute, so as to set compiling options.

3) Intermediate codes of parallel thread execution (PTX) are generated by using nvrtcCompileProgram compilation, according to the nvrtcProgram object, and the intermediate codes are stored in a character array.

4) A CUmodule object is generated by using the cuModuleLoadDataEx, according to the intermediate codes.

5) The compiled binary codes are obtained by using cuModuleGetFunction, according to the CUmodule object.

In addition, the binary codes may be invoked by using cuLaunchKernel.

In order to run the fusing codes generated dynamically online, a set of methods are needed for compiling codes online and managing codes online. A CUDA (compute unified device architecture) interface provides a NVRTC (runtime compilation) interface for compiling source codes online, so that binary codes running on the GPU may be generated. The compiling process may refer to the above operations 1) to 5).

As described in operation 103, for the fused operator, the corresponding operators in the operator graph are replaced with the fused operator respectively, and the dependence edges of the corresponding operators are coupled to the any fused operator. The corresponding operators include the operators in the operator group corresponding to the fused operator.

For example, a fused operator includes an operator a, an operator b, and an operator c. The operator a, the operator b, and the operator c in an operator graph may be replaced with the fused operator, so that the three operators may be fused into one operator. In addition, dependence edges of the operator a, dependence edges of the operator b and dependence edges of the operator c may be coupled to the fused operator, so that dependence relationships in the operator graph are not changed.

It should be noted that the embodiments above are described as a series of action combinations for convenience of description. However, those skilled in the art should understand that the present disclosure is not limited by the described action sequence. According to the present disclosure, some of the operations may be performed in other sequences or simultaneously. In addition, those skilled in the art should also understand that the embodiments in the description are optional and actions and modules involved are not indispensable in the present disclosure.

Method embodiments are described above, and the present disclosure is further described according to apparatus embodiments.

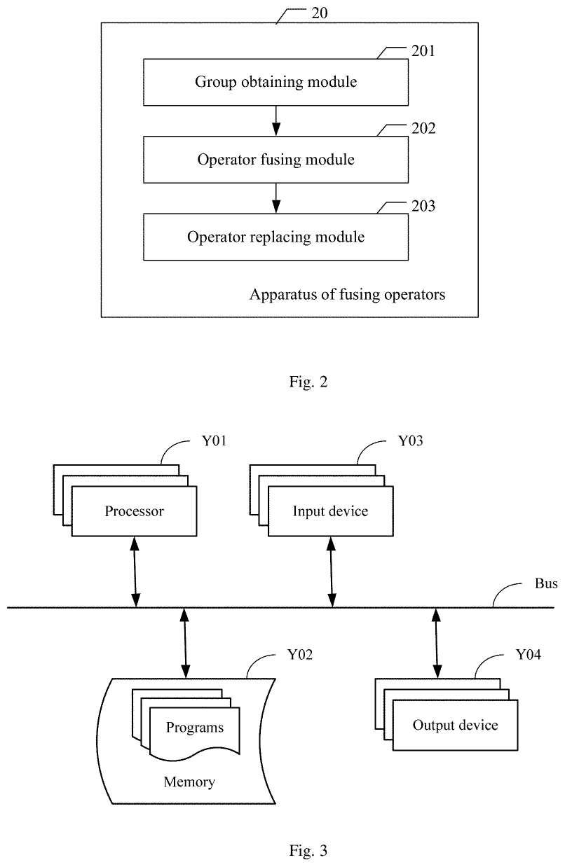

FIG. 2 is a schematic composition structure diagram of an apparatus 20 of fusing operators according to some embodiments of the present disclosure. As shown in FIG. 2, the apparatus 20 may include a group obtaining module 201, an operator fusing module 202 and an operator replacing module 203.

The group obtaining module 201 is configured to determine operator groups to be fused, according to an operator graph to be processed, wherein each operator group of the operator groups includes at least two operators in the operator graph respectively.

The operator fusing module 202 is configured to obtain a fused operator corresponding to the each operator group respectively.

The operator replacing module 203 is configured to, for the fused operator, replace corresponding operators in the operator graph with the fused operator respectively, and couple dependence edges of the corresponding operators to the any fused operator, wherein the corresponding operators include operators in the operator group corresponding to the fused operator.

As an optional implementation, the group obtaining module 201 may be used to perform a first processing as follows, so as to determine the operator groups to be fused. Operators in the operator graph are traversed. For each traversed operator in the operator graph, if it is determined that there is no dependence relationship between the each traversed operator and the any other operator, then an operator pair including the each traversed operator and any other operator is constructed, and the operator pair is set as a new operator, so as to replace the any traversed operator and the any other operator, and the dependence edges of the any traversed operator and the dependence edges of the any other operator are coupled to the new operator. The operators including at least two operators in the operator graph may be set as the operator groups to be fused, if it is determined that a termination condition is satisfied; and the first processing is re-performed, if it is determined that the termination condition is not satisfied.

In a practical application, an operator may an attribute indicating whether the operator is fusible. Generally, a non-fusible operator may not be processed according to the method described in the present disclosure.

Therefore, before the first processing, the group obtaining module 201 may be used to select fusible operators from the operators in the operator graph, so that a first operator set contains the selected fusible operators. In this manner, it is possible to determine whether both the any traversed operator and the any other operator are located in the first operator set, before determining that there is no dependence relationship between the each traversed operator and the any other operator. If it is determined that both the any traversed operator and the any other operator are located in the first operator set, the operator pair including the any traversed operator and the any other operator may be constructed, and subsequent processing may be performed. That is, an operator pair may be generated only if both the any traversed operator and the any other operator are located in the first operator set.

The termination condition may include failing to generate a new operator pair. In this case, there is no fusible operator. Alternatively, the termination condition may include a number of operators in a new generated operator pair being greater than a predetermined threshold. In this case, a new operator pair may be generated, but a number of operators in the new generated pair may be greater than a predetermined threshold.

A specific value of the predetermined threshold may be determined as needed. For example, the predetermined threshold may be set as a predetermined fused breadth constraint L, and the predetermined fused breadth constraint L may be a positive integer L greater than 1.

The operator fusing module 202 may be used to obtain the fused operator corresponding to the each operator group respectively. For example, a plurality of operators having no dependence relationship from each other may be fused into one operator (i.e., the fused operator may be obtained) based on an online compiling method of generating an operator.

As an optional implementation, operator fusing module 202 may be used to obtain fusing codes for the each operator group; and to obtain the fused operator, by compiling the fusing codes to generate binary codes.

Fusing codes for each operator group sᵢ may be obtained according to following operations.

1) For each operator vᵢ (vᵢ ϵsᵢ) in each operator group sᵢ, source codes kᵢ for the operator vᵢ and a thread space bᵢ for the operator vᵢ are obtained respectively.

2) The obtained thread spaces are fused, that is B=Σbᵢ.

3) A thread space for the fusing codes is declared, according to the fused thread space B.

4) Computing process is allocated for each thread subspace to complete executions for kᵢ.

5) A parameter list of the fusing codes is constructed, by generating a union of parameter lists for all the kᵢ.

Then, the fusing codes may be compiled to generate the binary codes according to following operations.

1) A nvrtcProgram object is created by using nvrtcCreateProgram, that is, the source codes (fusing codes) are encapsulated as a nvrtcProgram object by using nvrtcCreateProgram.

2) Framework parameters of a GPU are obtained by using cudaDeviceGetAttribute, so as to set compiling options.

3) Intermediate codes of PTX are generated by using nvrtcCompileProgram compilation, according to the nvrtcProgram object, and the intermediate codes are stored in a character array.

4) A CUmodule object is generated by using the cuModuleLoadDataEx, according to the intermediate codes.

5) The compiled binary codes are obtained by using cuModuleGetFunction, according to the CUmodule object.

In addition, the binary codes may be invoked by using cuLaunchKernel.

For the fused operator, the operator replacing module 203 may be used to replace the corresponding operators in the operator graph with the fused operator respectively, and to couple the dependence edges of the corresponding operators to the any fused operator. The corresponding operators include the operators in the operator group corresponding to the fused operator.

For specific workflow of the apparatus embodiments shown in FIG. 2, reference may be made to the relevant description in the method embodiments above, which will not be repeated.

According to the solution described in the apparatus embodiments, it is possible to automatically fuse operators in a lateral direction. The new operator may be generated to replace the original operators by using a compilation-based method. Thus, a computing efficiency and a training speed of a deep learning model may be improved. The solution is not constrained by a fixed mode, and has more application scenarios and optimization space.

According to the embodiments of the present disclosure, there is also provided an electronic device and a readable storage medium.

FIG. 3 is a block diagram of an electronic device according to some embodiments of the present application. The electronic device is intended to represent various forms of digital computers, such as laptop computers, desktop computers, workstations, personal digital assistants, servers, blade servers, mainframe computers, and other suitable computers. The electronic device may further represent various forms of mobile devices, such as personal digital processors, cellular phones, smart phones, wearable devices, and other similar computing devices. The components as illustrated herein and connections, relationships, and functions thereof are merely examples, and are not intended to limit the implementation of the disclosure as described and/or required herein.

As shown in FIG. 3, the electronic device includes one or more processors Y01, a memory Y02, and interface(s) for connecting various components, including high-speed interface(s) and low-speed interface(s). The various components are connected to each other by using different buses, and can be installed on a common motherboard or installed in other manners as required. The processor may process instructions executed in the electronic device, including instructions stored in or on the memory to display graphical information of GUI (Graphical User Interface) on an external input/output device (such as a display device coupled to an interface). In other embodiments, a plurality of processors and/or a plurality of buses may be used with a plurality of memories if necessary. Similarly, a plurality of electronic devices can be connected in such a manner that each electronic device providing a part of necessary operations (for example, as a server array, a group of blade servers, or a multi-processor system). One processor Y01 is taken as an example in FIG. 3.

The memory Y02 is the non-transitory computer-readable storage medium provided by this disclosure. The memory stores instructions executable by at least one processor, to cause the at least one processor to execute the method provided by the disclosure. The non-transitory computer-readable storage medium of the present disclosure stores computer instructions for allowing a computer to execute the method provided by the present disclosure.

As a non-transitory computer-readable storage medium, the memory Y02 can be used to store non-transitory software programs, non-transitory computer-executable programs, and modules, such as program instructions/modules corresponding to the method of constructing the fused relational network in the embodiment of the present disclosure. The processor Y01 performs various functional applications and data processing of the server by executing the non-transitory software programs, instructions, and modules stored in the memory Y02, thereby implementing the method in the method embodiments described above.

The memory Y02 may include a program storage area and a data storage area. The program storage area may store an operating system and an application program required by at least one function. The data storage area may store data etc. generated by using the electronic device. In addition, the memory Y02 may include a high-speed random access memory, and may further include a non-transitory memory, such as at least one magnetic disk storage device, a flash memory device, or other non-transitory solid-state storage devices. In some embodiments, the memory Y02 may optionally include a memory located remotely with respect to the processor Y01, and such remote memory may be connected to the electronic device. Examples of the network described above include, but are not limited to, Internet, intranet, local area network, mobile communication network, and combination thereof.

The electronic device may further include: an input device Y03 and an output device Y04. The processor Y01, the memory Y02, the input device Y03, and the output device Y04 may be connected by a bus or in other manners. In FIG. 3, the connection by a bus is taken as an example.

The input device Y03 may receive input information of numbers or characters, and generate key input signals related to user settings and function control of the electronic device, such as touch screen, keypad, mouse, trackpad, touchpad, indicator stick, one or more mouse buttons, trackball, joystick and other input devices. The output device Y04 may include a display device, an auxiliary lighting device (for example, LED), a tactile feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein can be implemented in digital electronic circuit systems, integrated circuit systems, application-specific ASICs (application-specific fused circuits), computer hardware, firmware, software, and/or combinations thereof. These embodiments may be implemented by one or more computer programs executed and/or interpreted on a programmable system including at least one programmable processor. The programmable processor can be a dedicated or general-purpose programmable processor, which may receive data and instructions from a storage system, at least one input device, and at least one output device, and transmit the data and instructions to the storage system, the at least one input device, and the at least one output device.

These computer programs (also referred as programs, software, software applications, or codes) include machine instructions for programmable processors, and may be implemented using high-level programming languages, object-oriented programming languages, and/or assembly/machine language to implement these calculation procedures. As used herein, the terms “machine-readable medium” and “computer-readable medium” refer to any computer program product, device, and/or device (e.g., magnetic disks, optical disks, memory, programmable logic devices (PLD)) for providing machine instructions and/or data to a programmable processor, including machine-readable media for receiving machine instructions as machine-readable signals. The term “machine-readable signal” refers to any signal for providing machine instructions and/or data to a programmable processor.

In order to implement interaction with the user, the systems and technologies described herein may be implemented on a computer including a display device (for example, CRT (Cathode Ray Tube) or LCD (Liquid Crystal Display)) display) for displaying information to the user; and a keyboard and a pointing device (for example, a mouse or a trackball) through which the user may provide the input to the computer. Other types of devices may also be used to implement interaction with the user. For example, the feedback provided to the user may be any form of sensory feedback (e.g., visual feedback, auditory feedback, or tactile feedback), and the input received from the user may be any form (including acoustic input, voice input, or tactile input).

The systems and technologies described herein may be implemented in a computing system including back-end components (for example, as a data server), or a computing system including middleware components (for example, an application server), or a computing system including front-end components (for example, a user computer having a graphical user interface or a web browser through which the user can interact with the implementation of the systems and technologies described herein), or a computing system including any combination of such back-end components, middleware components, or front-end components. The components of the system can be connected to each other through digital data communication (for example, a communication network) in any form or through any medium. Examples of communication networks include: LAN (Local Area Network), WAN (Wide Area Network), and Internet.

A computer system may include a client and a server. The client and server are generally far away from each other and usually interact through a communication network. The relationship between the client and the server is generated through computer programs running on the corresponding computers and having a client-server relationship with each other. The server may be a cloud server, also referred to as a cloud computing server or a cloud host, which is a host product in cloud computing service system. The cloud server solves the defects of difficult management and weak business scalability in traditional physical host and VPS services.

According to an embodiment of the present disclosure, interaction data from a plurality of data sources is obtained. The interaction data contains a plurality of user relationship information, and each user relationship information of the plurality of user relationship information contains identification information for two users having an interactive relationship and interaction information generated at one of the plurality of data sources between the two users; a node for the user in the fused relationship network is generated, based on the identification information for each user in each user relationship information, and an edge between the nodes of the two users in the fused relationship network is generated, based on the interaction information between two users in each user relationship information, and a same user identification is generated as one node. According to an embodiment of the present disclosure, user relationships from different data sources can be fused to generate a fused relationship network, so that the user coverage of the fused relationship network is larger, the amount of information is richer and more comprehensive, and is beneficial to an application extension of the user relationship network.

It should be understood that steps of the processes illustrated above can be reordered, added or deleted in various manners. For example, the steps described in the present disclosure can be performed in parallel, sequentially, or in different orders, as long as a desired result of the technical solution of the present disclosure can be achieved, and this is not limited herein.

The above embodiments do not constitute a limitation on the scope of protection of the disclosure. Those skilled in the art should understand that various modifications, combinations, sub-combinations, and substitutions can be made according to design requirements and other factors. Any modifications, equivalent replacements and improvements made within the spirit and principles of the disclosure shall be included in the scope of the disclosure.

I/we claim:

1. A method of fusing operators, comprising:
determining operator groups to be fused, according to an operator graph to be processed, wherein each operator group of the operator groups comprises at least two operators in the operator graph respectively;
obtaining a fused operator corresponding to the each operator group respectively; and
for the fused operator,
replacing corresponding operators in the operator graph with the fused operator respectively, and
coupling dependence edges of the corresponding operators to the any fused operator,
wherein the corresponding operators comprise operators in the operator group corresponding to the fused operator.

2. The method of claim 1, wherein the determining operator groups to be fused, according to an operator graph to be processed comprises:
performing a first processing on the operator graph, comprising:
traversing operators in the operator graph, and
for each traversed operator in the operator graph,
constructing an operator pair including the each traversed operator and any other operator, in response to determining that there is no dependence relationship between the each traversed operator and the any other operator,
setting the operator pair as a new operator, so as to replace the any traversed operator and the any other operator, and
coupling dependence edges of the any traversed operator and dependence edges of the any other operator to the new operator; and
setting operators including at least two operators in the operator graph as operator groups to be fused, in response to determining that a termination condition is satisfied; and re-performing the first processing, in response to determining that the termination condition is not satisfied.

3. The method of claim 2, further comprising:
selecting fusible operators from the operators in the operator graph, so that a first operator set contains the selected fusible operators; and
constructing the operator pair including the any traversed operator and the any other operator, in response to determining that both the any traversed operator and the any other operator are located in the first operator set.

4. The method of claim 2, wherein the termination condition comprises:
failing to generate a new operator pair.

5. The method of claim 2, wherein the termination condition comprises:
a number of operators in a new generated operator pair being greater than a predetermined threshold.

6. The method of claim 1, wherein the obtaining a fused operator corresponding to the each operator group comprises:
obtaining fusing codes for the each operator group; and
obtaining the fused operator, by compiling the fusing codes to generate binary codes.

7. An electronic device, comprising:
at least one processor; and
a memory, communicatively coupled with the at least one processor; wherein, the memory stores instructions capable of being executed by the at least one processor, and the instructions, when executed by the at least one processor, cause the at least one processor to perform operations of fusing operators, comprising:
determining operator groups to be fused, according to an operator graph to be processed, wherein each operator group of the operator groups comprises at least two operators in the operator graph respectively;
obtaining a fused operator corresponding to the each operator group respectively; and
for the fused operator,
replacing corresponding operators in the operator graph with the fused operator respectively, and
coupling dependence edges of the corresponding operators to the any fused operator,
wherein the corresponding operators comprise operators in the operator group corresponding to the fused operator.

8. The electronic device of claim 7, wherein the instructions, when executed by the at least one processor, cause the at least one processor further to perform operations of:
performing a first processing on the operator graph, comprising:
traversing operators in the operator graph, and
for each traversed operator in the operator graph,
constructing an operator pair including the each traversed operator and any other operator, in response to determining that there is no dependence relationship between the each traversed operator and the any other operator,
setting the operator pair as a new operator, so as to replace the any traversed operator and the any other operator, and
coupling dependence edges of the any traversed operator and dependence edges of the any other operator to the new operator; and
setting operators including at least two operators in the operator graph as operator groups to be fused, in response to determining that a termination condition is satisfied; and re-performing the first processing, in response to determining that the termination condition is not satisfied.

9. The electronic device of claim 7, wherein the instructions, when executed by the at least one processor, cause the at least one processor further to perform operations of:
selecting fusible operators from the operators in the operator graph, so that a first operator set contains the selected fusible operators; and
constructing the operator pair including the any traversed operator and the any other operator, in response to determining that both the any traversed operator and the any other operator are located in the first operator set.

10. The electronic device of claim 7, wherein the termination condition comprises:
failing to generate a new operator pair.

11. The electronic device of claim 7, wherein the termination condition comprises:
a number of operators in a new generated operator pair being greater than a predetermined threshold.

12. The electronic device of claim 1, wherein the instructions, when executed by the at least one processor, cause the at least one processor further to perform operations of:
obtaining fusing codes for the each operator group; and
obtaining the fused operator, by compiling the fusing codes to generate binary codes.

13. A non-transitory computer readable storage medium storing computer instructions and configured to cause the computer to perform operations of fusing operators, comprising:
determining operator groups to be fused, according to an operator graph to be processed, wherein each operator group of the operator groups comprises at least two operators in the operator graph respectively;
obtaining a fused operator corresponding to the each operator group respectively; and
for the fused operator,
replacing corresponding operators in the operator graph with the fused operator respectively, and
coupling dependence edges of the corresponding operators to the any fused operator,
wherein the corresponding operators comprise operators in the operator group corresponding to the fused operator.

14. The non-transitory computer readable storage medium of claim 13, further configured to cause the computer to perform operations of:
performing a first processing on the operator graph, comprising:
traversing operators in the operator graph, and
for each traversed operator in the operator graph,
constructing an operator pair including the each traversed operator and any other operator, in response to determining that there is no dependence relationship between the each traversed operator and the any other operator,
setting the operator pair as a new operator, so as to replace the any traversed operator and the any other operator, and
coupling dependence edges of the any traversed operator and dependence edges of the any other operator to the new operator; and
setting operators including at least two operators in the operator graph as operator groups to be fused, in response to determining that a termination condition is satisfied; and re-performing the first processing, in response to determining that the termination condition is not satisfied.

15. The non-transitory computer readable storage medium of claim 13, further configured to cause the computer to perform operations of:
selecting fusible operators from the operators in the operator graph, so that a first operator set contains the selected fusible operators; and
constructing the operator pair including the any traversed operator and the any other operator, in response to determining that both the any traversed operator and the any other operator are located in the first operator set.

16. The non-transitory computer readable storage medium of claim 13, wherein the termination condition comprises:
failing to generate a new operator pair.

17. The non-transitory computer readable storage medium of claim 13, wherein the termination condition comprises:
a number of operators in a new generated operator pair being greater than a predetermined threshold.

18. The non-transitory computer readable storage medium of claim 13, further configured to cause the computer to perform operations of:
obtaining fusing codes for the each operator group; and
obtaining the fused operator, by compiling the fusing codes to generate binary codes.
